(19) United States
(12) Patent Application Publication
(10) Pub. No.: US 2005/0091813 A1
(43) Pub. Date: May 5, 2005

(54) Valve stem cap apparatus

(76) Inventor: Jerry P. Warren, Channelview, TX (US)

Correspondence Address: STURM & FIX LLP, 206 SIXTH AVENUE, SUITE 1213, DES MOINES, IA, 50309-4076, US

(21) Appl. No.: 10/698,733

(22) Filed: Nov. 3, 2003

(51) Int. Cl. B23P 19/04

(52) U.S. Cl. 29/221.5

(57) ABSTRACT

A cap removal apparatus (10) including a resiliently deformable hollow tubular cap engaging member (20) having an internal passageway (22) having an outboard end dimensioned to engage, rotate and remove the cap (101) of a tire inflation valve stem (100) on a dual tire arrangement 200 wherein, the central passageway (22) is dimensioned to frictionally engage one end of a shaft member (30) the opposite end of which terminates in an enlarged handle member (40).

In addition, the cap engaging member is further provided with a first securing band (23) for captively engaging the cap engaging member (20) to the shaft member (30) and a second tensioning band (24) for limiting the amount of distortion or enlargement of the outboard end of the passageway (22) of the cap engaging member (20).

### CROSS REFERENCE TO RELATED APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### BACKGROUND OF THE INVENTION

1. Field of the Invention

The present invention relates to the field of valve stem cap removal devices in general, and in particular to a valve stem cap removal apparatus having a resiliently deformable cap engagement member.

2. Description of Related Art

As can be seen by reference to the following U.S. Pat. Nos. 5,614,669; 3,928,902; Des. 399,107; and 4,528,735, the prior art is replete with automotive accessory tools designed for engagement with different portions of an automobile tire inflation valve stem assembly.

While all of the aforementioned prior art constructions are more than adequate for the basic purpose and function for which they have been specifically designed, they are uniformly deficient with respect to their failure to provide a simple, efficient, and practical valve stem cap removal apparatus having a resiliently deformable cap engaging head member that facilitates the frictional engagement and removal of the valve stem cap.

Unfortunately when dealing with rigid cap engaging members, the valve stem must be almost perfectly aligned with the opening of the outside wheel of a dual wheel application in order to effectively utilize this type of tool; and, in many instances, the valve stem is somewhat laterally offset from the aforementioned desired alignment.

As a consequence of the foregoing situation, there has existed a longstanding need for a new and improved valve stem cap removal apparatus that is designed to be both flexible and resiliently deformable to engage the cap on valve stems that are either not perfectly aligned with a wheel aperture or positioned on the inner wheel of a dual wheel arrangement; and the provision of such a construction is a stated objective of the present invention.

### BRIEF SUMMARY OF THE INVENTION

Briefly stated, the valve stem cap removal apparatus that forms the basis of the present invention comprises a resilient cap engaging unit the inboard end of which is secured to the outboard end of an elongated generally rigid shaft member having an inboard end provided with an enlarged handle member.

As will be explained in greater detail further on in the specification, the cap engaging unit includes a generally resiliently deformable tubular cap engaging member preferably fabricated from rubber or flexible plastic wherein, the inboard end of the tubular cap engaging member is dimensioned to frictionally engage the outboard end of the shaft member and wherein, the cap engaging member is adapted to frictionally engage the cap of a valve stem.

In addition, the tubular cap engaging member is further provided with a first securing band that captively engages the inboard end of the cap engaging member to the outboard end of the shaft member, and a second tensioning band that limits the amount of deformation of the outboard end of the cap engaging member to substantially retain the effective inside diameter of the outboard end of the cap engaging member after repeated usage.

### BRIEF DESCRIPTION OF THE SEVERAL VIEWS OF THE DRAWINGS

These and other attributes of the invention will become more clear upon a thorough study of the following description of the best mode for carrying out the invention, particularly when reviewed in conjunction with the drawings, wherein:

FIG. 1 is a perspective view of the cap removal apparatus in use;

FIG. 2 is a cross-sectional view of the outboard end of the apparatus prior to engaging the cap of a valve stem;

FIG. 3 is a cross-sectional view showing the engagement of the cap removal member with the cap of a valve stem; and,

FIG. 4 is a cross-sectional view showing the cap of a valve stem detached from the valve stem by the cap removal member.

### DETAILED DESCRIPTION OF THE INVENTION

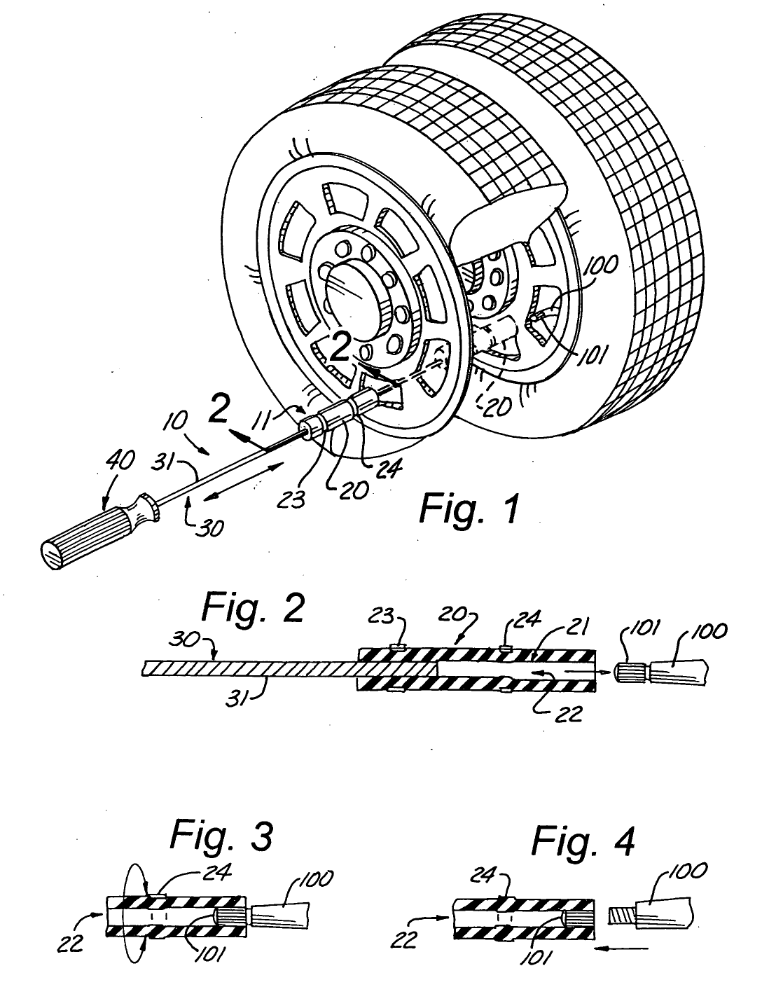

As can be seen by reference to the drawings, and in particularly to FIG. 1, the valve stem cap removal apparatus that forms the basis of the present invention is designated generally by the reference number 10. The apparatus 10 comprises a cap removal unit 11 attached to a generally elongated shaft member 30 equipped with an enlarged handle member 40. These structural components will now be described in seriatim fashion.

As can best be seen by reference to FIG. 2, the cap removal unit 11 comprises in general a tubular cap engaging member 20 fabricated from a resiliently deformable material 21 such as rubber, flexible plastic or the like wherein, in the preferred embodiment of the invention, the tubular cap engaging member 20 has a generally uniform diameter interior passageway 22.

In addition, as depicted in FIGS. 1 and 2, the exterior of the cap engaging member 20 is further provided with a first securing band 23 disposed proximate to its inboard end; and, a second tensioning band 24 spaced from the outboard end of the cap engaging member 20 wherein, the purpose and function of the securing 23 and tensioning 24 bands will be explained in greater detail further on in the specification.

Still referring to FIGS. 1 and 2, it can be seen that the generally elongated shaft member 30 is fabricated from a generally rigid material 31 wherein, the outboard end of the shaft member 30 is frictionally engaged by the inboard end of the interior passageway 22 of the cap engaging member 20 and held in place relative thereto by the crimping action of the securing band 23 in a well recognized manner.

As can also be appreciated by reference to FIG. 1, the inboard end of the shaft member 30 is fixedly secured in an enlarged handle member 40 having a frictionally enhanced external peripheral surface 41 wherein, the frictionally enhanced peripheral handle surface 41 may be accomplished by ribs, a frictional coating or material that the handle is fabricated from or a combination thereof.

Turning now to FIGS. 2 through 5, it can be appreciated that the tensioning band 24 is provided to limit the amount of expansion of the outboard end of the central passageway 22 of the cap engaging member 20 as it engages, rotates, and removes the cap 101 of a tire inflation valve stem 100.

Furthermore, the intermediate portion of the cap engaging member 20 may be resiliently deformed to gain access to a valve stem cap 101 on the inner wheel 200′ of a dual wheel arrangement 200 that would not be capable of being accessed by a rigid cap engaging element.

Although only an exemplary embodiment of the invention has been described in detail above, those skilled in the art will readily appreciate that many modifications are possible without materially departing from the novel teachings and advantages of this invention. Accordingly, all such modifications are intended to be included within the scope of this invention as defined in the following claims.

Having thereby described the subject matter of the present invention, it should be apparent that many substitutions, modifications, and variations of the invention are possible in light of the above teachings. It is therefore to be understood that the invention as taught and described herein is only to be limited to the extent of the breadth and scope of the appended claims.

1. An apparatus for engaging, rotating and removing the cap of a tire inflation valve stem wherein, the apparatus comprises
a handle member
a generally rigid shaft member having an inboard end attached to the handle member and further having an outboard end
a cap removal unit including a resiliently deformable cap engaging member having a longitudinal axis, an inboard end connected to the outboard end of the shaft member, and an outboard end provided with a passageway that extends at least partially into the cap engaging member wherein, the passageway is dimensioned to frictionally engage a cap of a tire inflation valve stem.

2. The apparatus as in claim 1; wherein, the cap engaging member is further provided with a tensioning band spaced inwardly from the outboard end of the cap engaging member.

3. The apparatus as in claim 1; wherein, said passageway extends along the entire longitudinal axis of the tubular cap engaging member.

4. The apparatus as in claim 3; wherein, said passageway has an inboard end dimensioned to frictionally engage the outboard end of the shaft member.

5. The apparatus as in claim 4; wherein, the cap engaging member is further provided with a tensioning band spaced inwardly from the outboard end of the cap engaging member.

6. The apparatus as in claim 5; wherein, the cap engaging member is further provided with a securing band for captively engaging the shaft member relative to the cap engaging member.

7. The apparatus as in claim 4; wherein, the cap engaging member is further provided with a securing band for captively engaging the cap engaging member relative to the shaft member.

8. The apparatus as in claim 7; wherein, the cap engaging member is further provided with a tensioning band spaced inwardly from the outboard end of the cap engaging member.
